(19) United States
(12) Patent Application Publication
(10) Pub. No.: US 2023/0409717 A1
(43) Pub. Date: Dec. 21, 2023

(54) SYSTEM AND METHOD FOR DETECTING VULNERABILITIES IN THE OPERATING SYSTEM BASED ON PROCESS AND THREAD DATA

(71) Applicant: AO Kaspersky Lab, Moscow (RU)

(72) Inventors: Alexey V. Monastyrsky, Moscow (RU); Dmitry A. Kondratyev, Moscow (RU)

(21) Appl. No.: 18/157,861

(22) Filed: Jan. 23, 2023

(30) Foreign Application Priority Data
Jun. 15, 2022 (RU) 2022116157

(51) Int. Cl. G06F 21/57; G06F 21/51

(52) U.S. Cl. CPC G06F 21/577; G06F 2221/034; G06F 21/51

(57) ABSTRACT

A method for detecting a vulnerability in an operating system based on process and thread data, includes the steps of: detecting one or more launches of one or more threads associated with one or more processes in an operating system (OS); generating a set of privileges based on the detected one or more launches; analyzing the generated set of privileges to identify illegitimate changes in privileges; detecting a vulnerability in the OS using one or more rules for detecting a vulnerability based on the analyzed set of privileges; and isolating a file that exploited the detected vulnerability, in response to detecting the vulnerability.

### CROSS-REFERENCE TO RELATED APPLICATION

This application claims benefit of priority under 35 U.S.C. 119(a)-(d) to a Russian Application No. 2022116157 filed on Jun. 15, 2022, which is incorporated by reference herein.

### FIELD OF TECHNOLOGY

The present disclosure relates generally to the field of information security, and more specifically to systems and methods for detecting vulnerabilities in the operating system based on process and thread data.

### BACKGROUND

The proliferation of devices connected to the Internet, the ‘Internet of Things’, has tremendously increased network traffic volume, transmission speeds and usage on communications networks. At the same time, the number of programs and applications being created is also increasing.

Various programs and applications typically interact with an operating system (OS). A plurality of user and system applications are supported by the OS. On one hand, the OS typically relies on the basic software of the computer, which is included in its BIOS (Basic Input-Output System). On the other hand, the OS supports software and most of services at higher levels.

A process is a program that is currently executing. A process is defined as an entity that represents the basic unit of work that should be implemented in the OS. Typically, any OS should be configured to start, pause, execute, terminate execution, and synchronize processes with each other. For each process, the OS typically provides its own address space. In the simplest case, a process consists of a single thread. Both the process and the thread are associated with certain program code (source code files), which may be formatted as an executable module.

There are many different vulnerabilities that virus writers may use to modify or replace the attributes of a process. The intent of such modifications may include the escalation of privileges that process has for the execution of malicious code. The ways in which the modification is implemented depends significantly on a particular vulnerability. However, it may be very difficult to determine general aspects of such a modification or the vulnerability itself, including the vulnerability that has not been discovered yet.

There are many ways to compare information about the OS process to detect malware.

Thus, there is a need for effective detection of vulnerabilities that change the privileges of processes.

### SUMMARY

Aspects of the present disclosure are directed to ensuring the security of the OS by substantially suppressing the threat of privilege spoofing caused by the presence of a vulnerability in the OS. Advantageously, the aforementioned result may be achieved by isolating the file that exploited the detected vulnerability. In an aspect, vulnerability detection may be performed using one or more vulnerability detection rules based on the result of analysis identifying illegal changes in the privileges of a process or thread.

In an aspect, a method for detecting a vulnerability in an operating system based on process and thread data, may include the steps of: detecting one or more launches of one or more threads associated with one or more processes in an operating system (OS); generating a set of privileges based on the detected one or more launches; analyzing the generated set of privileges to identify illegitimate changes in privileges; detecting a vulnerability in the OS using one or more rules for detecting a vulnerability based on the analyzed set of privileges; and isolating a file that exploited the detected vulnerability, in response to detecting the vulnerability.

In an aspect, the set of privileges comprises a data set containing data about the one or more threads, one or more processes, and security context, wherein the security context includes access token information and a list of privileges.

In an aspect, the generated set of privileges is analyzed by identifying at least one privilege usage event in the OS.

In an aspect, the at least one privilege usage event in the OS is detected by intercepting an OS event containing updated privilege indicative of an activity of one or more malicious applications.

In an aspect, the one or more launches are detected by intercepting an OS event that indicates a launch of a new thread or a launch of a new process.

In an aspect, the generated set of privileges is analyzed by identifying one or more access tokens that have been changed.

In an aspect, each of the one or more rules for detecting a vulnerability comprises a set of conditions which indicate presence of a vulnerability in the OS if the conditions are met.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 shows schematically a particular example of a system configured to run several arbitrary executable files in an OS.

FIG. 2 shows schematically a particular example of a basic structure of a system for detecting vulnerabilities in an operating system based on process and thread data.

FIG. 3 is a flow chart illustrating an example method for detecting the presence of a vulnerability in an operating system based on process and thread data.

FIG. 4 shows an example of a computer system on which the variant aspects of systems and methods disclosed herein may be implemented.

### DETAILED DESCRIPTION

The above aspects and exemplary embodiments of the disclosure are described in the detailed description with reference to the figures. In the figures, like numerals may reference like elements and descriptions of some elements may not be repeated.

Glossary: a number of terms are defined herein which will be used to describe variant aspects of the present disclosure.

A “process”, as used herein, refers to a sequence of operations performed during execution of a program, as well as data used by this sequence of operations. The operating system considers a process to be a single entity during the allocation of resources.

Process is a basic concept of OS, often briefly defined as a program under execution. A “program”, as used herein, refers to a static object that is a source code file and data. Furthermore, a “process”, as used herein, refers to a dynamic object that is generated in the OS after a program is launched for execution. In other words, a process is a self-sufficient unit of computational work.

Modern general purpose operating systems are designed to be able to divide a process into smaller components. As used herein, the term “thread” refers to a single instruction stream and its associated state. Similar to how the concept of process is used in UNIX, Windows NT, NetWare, and similar operating systems, the concept of “task” is used in OS/2, etc.

The time resource (in the form of CPU runtime quanta allocations) may be distributed by the OS among smaller units of computational work—threads. Such distributed architecture may produce a calculations parallelization plan within one process. At the same time, the OS may assign the process an address space and a set of resources that may be shared by all threads of one process. Note that in single-tasking systems there is no need to introduce the concept denoting the unit of computational work, since there is no problem of dividing resources between tasks (processes).

Each process and a thread corresponding to that process may provide the resources needed to run the program and may contain attributes, such as, but not limited to, a virtual address space, executable code, open handle, security context, unique process identifier (UID), environment variables, priority class, working set size and at least one thread of execution. Each process may start with a single thread, often referred to as the main thread, but additional threads may be created from any thread.

An “access token”, as used herein, refers to an object that describes the security context of a process or thread. The information in the token may include the identity and privileges of the user account that is associated with the process or thread. When a user logs on, the system may validate the user's password by comparing the password entered by the user to the information stored in the secure database. If the entered password is authenticated, the system may generate an access token. Every process running on behalf of this user may have a copy of the access token. The system may use an access token to indicate to the user when a thread interacts with a securable object (objects that have a security descriptor)) or when a thread attempts to perform a system task that requires privileges. Access tokens may contain information about the parameters of the process (thread), including, but not limited to:
the security identifier (SID) for the user account;
SIDs for groups of which the user is a member;
a logon SID that identifies the current logon session;
a list of privileges stored by the user or in the user's groups;
the owner's SID;
the SID for the primary group;
the default Discretionary Access Control List (DACL) used by the system when a user creates a securable object without specifying a security descriptor;
the source of the access token;
information indicating whether the token is a primary token (a token that identifies the security context) or an impersonation token (a token that temporarily borrows another user's security context);
information indicating current impersonation levels (with impersonation tokens reporting an impersonation level that determines what type of impersonation is active in the token).

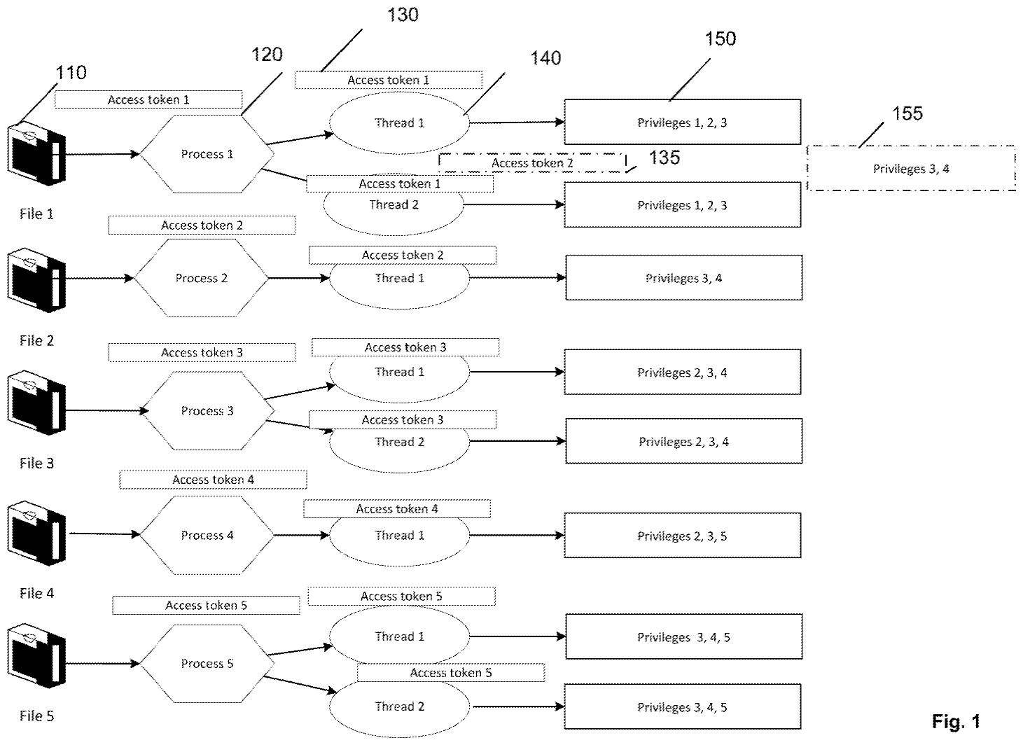

FIG. 1 shows schematically a particular example of a system configured to run several arbitrary executable files in an OS. During the startup of each file 110, at least one process 120 may be created by an OS. Each process 120 may create at least one thread 140 that may inherit the access token 130 of the process 120. Each access token 130 may include a list of privileges 150, which may describe access rights and permissions. Attackers may potentially exploit the ability to elevate the privilege level of a process through vulnerabilities. In an aspect, an attacker may attempt to illegitimately change privileges by assigning or modifying the access token of one thread (process) to another thread (process). In this case, the process 120 may receive the changed privileges 155 using the modified access token 135. An “illegitimate change in privileges”, as used herein, refers to changed privileges that are not provided by the developer of the OS and are performed only as a result of an OS security violation. In another aspect, an attacker may attempt to illegitimately change privileges by updating or changing a thread of its own list of privileges. In an aspect, illegal changes in the access token may be detected using the vulnerability detection system in the operating system based on process and thread data.

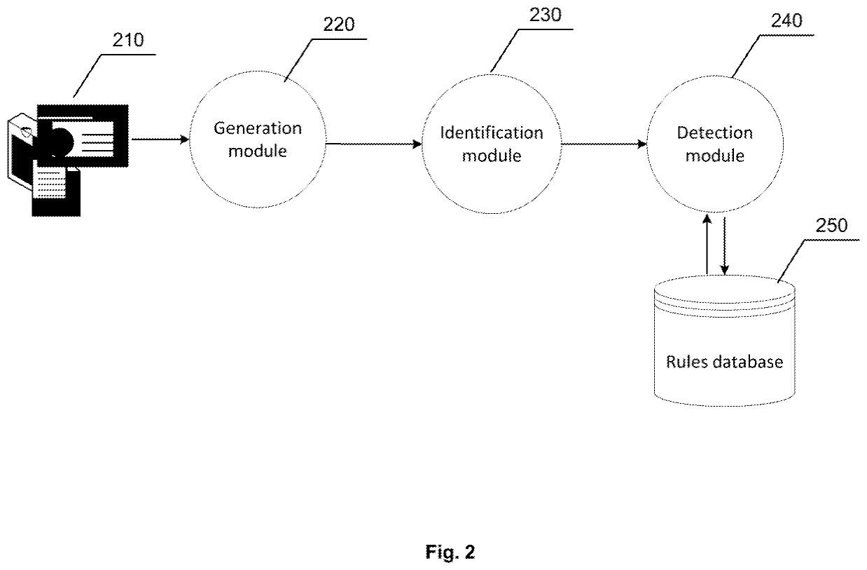

FIG. 2 shows schematically a particular example of a basic structure of a system for detecting vulnerabilities in an operating system based on process and thread data, in accordance with aspects of the present disclosure, in an aspect, the system may include a log of all recorded events in OS 210, a generation module 220, an identification module 230, a detection module 240, rules database 250.

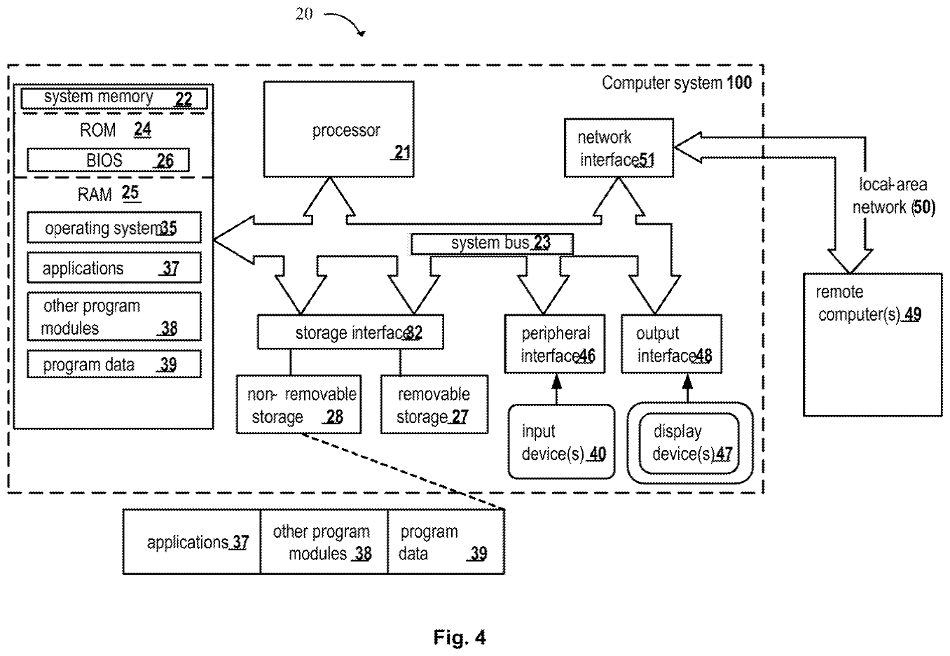

The system shown in FIG. 2 may be implemented by a computer system, such as the computer system shown in FIG. 4 having a hardware processor and memory. Said system may include functional and/or hardware modules and facilities 210-250, which in turn may include instructions for execution on a hardware processor. Aspects of the modules and modules 210-250 are described in greater detail below.

In an aspect, the generation module 220 may be configured to detect the start of each thread corresponding to a process running on the OS. The generation module 220 may be configured to analyze and detect the start of each thread of each process by intercepting OS events from the log of all recorded events in the OS 210 that may indicate the initialization of a new thread or process. In an aspect, the generation module 220 may perform analysis of events in real time. In the event that the OS performed some work before the initiation of the disclosed system, the generation module 220 may analyze the event log in its entirety.

Furthermore, the generation module 220 may be configured to generate a set of actual privileges of threads (processes) based on the identified launches. In addition, the generation module 220 may pass the generated set of actual privileges to the identification module 230. In an aspect, the generation module 220 may generate a set of actual privileges of threads (processes) by analyzing all detected launches of threads for each process running in the OS. A set of actual privileges may include, but is not limited to, a set of data that contains information about each running thread, process, such as security context, which may include an access token and a list of privileges.

In an aspect, to save OS resources, the generation module 220 may analyze processes and/or threads that were previously unknown or changed. Data about known threads and processes of trusted files may be obtained from available sources, such as, but not limited to, a database of trusted files, an antivirus server or saved results from a previous analysis, or analyses, and checks. Thus, in this aspect, the generation module 220 may reduce the load on the OS.

In another aspect, the generation module 220 may analyze only the threads of those processes for which there are known cases of use various vulnerabilities to change privileges and elevate access rights.

For example, referring back to FIG. 1, in OS 1, five files may be started, for the execution of which 5 processes may be launched. Processes 1, 3 and 5 may have two threads each. Process 2 and process 4 may have one thread. In an aspect, the generation module 220 may generate a set of actual privileges in the form of a table, for example: process 1, thread 1, access token 1, privilege list 1; process 1, thread 2, access token 1, privilege list 1, and the like.

In an aspect, the identification module 230 may be configured to check the generated set of privileges to identify illegitimate changes in privileges. This check may be performed by the identification module 230 in response to detecting at least one privilege usage event in the OS.

The identification module 230 may detect at least one privilege usage event in the OS by intercepting an OS event containing updated privilege usage activity typical of malicious applications. Such OS events may include, but are not limited to, the launch of child threads (processes), registry change operations, operations involving reads and modifications of files, as well as other operations that take advantage of the changed privileges.

In an aspect, the identification module 230 may check the generated set for illegitimate privilege changes by searching for thread access tokens that have been changed. In an aspect, the identification module 230 may pass the results of the check to the detection module 240.

Continuing with the above example, the identification module 230 may determine that a privilege usage event has occurred, after which, the identification module 230 may check all access tokens from the set of actual privileges for changes. Referring, back to FIG. 1, assume that access token 1 of process 1 thread 2 has been changed. When all access tokens are validated, the identification module 230 may generate a validation result and may send the results for further processing to the detection module 240.

The detection module 240 may be configured to detect the presence of a vulnerability in the operating system using the rules for detecting a vulnerability from the rules database 250 based on the result of the check.

The “rule for detecting vulnerabilities,” as used herein, refers to a set of conditions satisfaction of which indicates that the OS contains a vulnerability.

One example of a vulnerability detection rule might be the following set of conditions: the access token of one of the threads has been changed, the modified access token is unique, and there are no privilege changes. If the above set of conditions is met, the detection module 240 may determine that no vulnerabilities in the OS have been detected.

Another example of a vulnerability detection rule might be the following set of conditions: the access token of one of the threads has been changed, the modified access token is not unique, and privileges have been added. If the above set of conditions is met, the detection module 240 may determine that a vulnerability has been discovered in the OS.

Another example of a vulnerability detection rule might be the following set of conditions: the access token of one of the threads is changed, the modified access token is unique, and the removal of privileges is detected. If the above set of conditions is met, the detection module 240 may determine that a vulnerability has been discovered in the OS.

The rules database 250 may be configured to store vulnerability detection rules. Different types of databases can be used as a rules database 250, including, but not limited to: hierarchical databases (IMS, TDMS, System 2000), network databases (Cerebrum, Cronospro, DBVist), relational databases (DB2, Informix, Microsoft SQL Server), object-oriented databases (Jasmine, Versant, POET), object-relational databases (Oracle Database, PostgreSQL, FirstSQL/J). In an aspect, rules stored in the rules database 250 may be created using machine learning algorithms and automated processing of large amounts of data.

If a vulnerability is detected in the OS, the file during execution of which the thread (process) that changed the privileges has been launched may be considered to be dangerous and may perform malicious actions. Thus, the disclosed system may need to isolate the aforementioned file, complete execution of the process (thread) and perform an in-depth scan for malicious code. The detection module 240 may be configured to isolate a file that exploited the detected vulnerability.

In an aspect, during isolation, the detection module 240 may analyze the processes (threads) and files associated with the processes (threads) of the isolated file. During the analysis, the detection module 240 may reveal a complete list of attributes of processes (threads) that interacted with the isolated file in one way or another.

In another aspect, during isolation, the detection module 240 may analyze the behavior of the processes (threads) of the isolated file. In some cases, the detection module 240 may completely restore the access token and privileges of the processes (threads) of the isolated file and may initiate an in-depth analysis of the behavior of the isolated file. In this case, if the procedure for illegally changing privileges is repeated, the process (thread) and the file that directly initiates this procedure may be identified by the detection module 240.

Collectively, information about the links of an isolated file and information about the file that initiates the procedure for changing privileges may enable the detection module 240 to identify the object containing the vulnerability, or greatly narrow the range of such objects.

Continuing with the example illustrated in FIG. 1, it may be possible that the access token 1 of thread 2 process 1 is identical to the access token 2 of thread 1 process 2. Thread 2 of process 1, which had privileges from privilege list 1, namely privileges number 1, 2, 3, may now have privileges number 3, 4 of thread 1 of process 2. In this case, a vulnerability detection rule may be triggered. Thus, the detection module 240 may detect a vulnerability in the OS that was used by file 1, for the execution of which thread 2 of process 1 was launched. Accordingly, the detection module 240 may isolate file 1.

Below are the details of the implementation of the system illustrated in FIG. 2 in a simplified form.

### Example 1

1. When an antivirus program starts, all processes with the system privilege level may be enumerated and paired into an array in the form of a unique identifier of the process and its corresponding unique identifier of the access token.
2. When a process with System privileges is created/terminated, the above pairs may be added/deleted to the array.
3. On certain events of activity, processes with less privileges receive the current unique identifier of the access token.
4. If the access token ID obtained matches the access token ID of another process, then the access token has been “stolen”, and measures to prevent malicious actions on the part of the process that stole the access token may be taken, as well as additional measures to roll back the system to the state before the access token was stolen.

### Example 2

1. When an antivirus program starts, all processes with a low level of privileges may be listed. For each of these processes, their current state of the structure TOKEN_PRIVILEGES may be saved. The structure of the TOKEN_PRIVILEGES may include information about the number of privileges in the access token, as well as information about the privilege number and its status (for example, enabled (1), enabled by default (2), disabled (3), activated on request (4) (.

Below is an example TOKEN_PRIVILEGES when starting a process without administrator rights:

Length: 5 (Number of privileges in the access token)

Privilege number/its condition:
19 0
23 3
25 0
33 0
34 0
2. When creating/terminating a process with low privileges, process' privileges may be similarly saved.
3. On certain events, low-privilege processes may receive their current privileges.
4. If new privileges are added to the TOKEN_PRIVILEGES that did not exist initially, and the modification is recognized as illegitimate, then measures may be taken to prevent malicious actions on the part of the process that stole the access token, as well as additional measures to roll back the system to the state before the access token was stolen. Below is an example TOKEN_PRIVILEGES of a non-administrator process from the previous example, which elevated privileges by exploiting a vulnerability (in total, there are 31 privileges in the list):

Length: 31
2 2
3 2
4 2
5 2
7 2
8 2
9 2
10 2
11 2
12 2
13 2
14 2
15 2
16 2
17 2
18 2
19 2
20 2
21 2
22 2
23 3
25 2
28 2
29 2
30 3
31 2
32 2
33 2
34 2
35 2
36 2

Advantageously, the disclosed system enables detection of a large layer of vulnerabilities that change the access token to increase privileges. For example, such vulnerabilities may be vulnerabilities CVE-2018-8453, CVE-2020-0796 in Windows operating system.

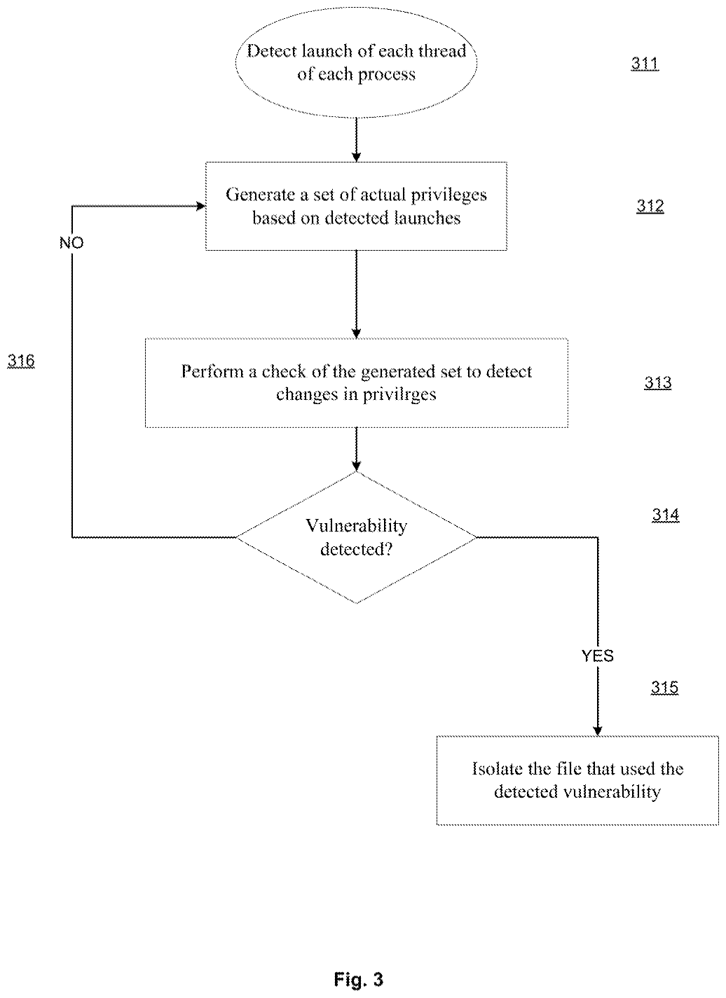

FIG. 3 is a flow chart illustrating an example method for detecting the presence of a vulnerability in an operating system based on process and thread data, in accordance with aspects of the present disclosure. At step 311, the generation module 220 may detect the start of each thread of each process running in the OS. The generation module 220 may be configured to analyze and detect the launch of each thread of each process by intercepting the OS events from the log of all recorded events in the OS 210, that may indicate the initialization of a new thread or process. In an aspect, the generation module 220 may perform analysis of events in real time.

At step 312, the generation module 220 may generate a set of actual privileges based on the identified launches and may pass data about the generated set of actual privileges to the identification module 230. In an aspect, the generation module 220 may generate a set of actual privileges of threads (processes) by analyzing all detected launches of threads for each process running in the OS. A set of actual privileges may include, but is not limited to a set of data that contains information about each running thread, process, such as security context, which may include an access token and a list of privileges.

At step 313, the identification module 230 may perform a check of the generated set for changes in privileges and may pass the results of the check to the detection module 240. This check may be performed by the identification module 230 in response to detecting at least one privilege usage event in the OS. The identification module 230 may detect at least one privilege usage event in the OS by intercepting an OS event containing updated privilege usage activity typical of malicious applications. Such OS events may include, but are not limited to, the launch of child threads (processes), registry change operations, operations involving reads and modifications of files, as well as other operations that take advantage of the changed privileges.

At step 314 the detection module 240 may detect the presence of a vulnerability in the operating system using the rules for detecting a vulnerability from the rules database 250 based on the results of the check. One example of a vulnerability detection rule might be the following set of conditions: the access token of one of the threads has been changed, the modified access token is not unique, and privileges have been added. If the above set of conditions is met, the detection module 240 may determine that a vulnerability has been discovered in the OS.

If a vulnerability is detected (decision block 314, “YES” branch), at step 315, the detection module 240 may isolate the file that used the detected vulnerability. In an aspect, during isolation, the detection module 240 may analyze the processes (threads) and files associated with the processes (threads) of the isolated file. During the analysis, the detection module 240 may reveal a complete list of attributes of processes (threads) that interacted with the isolated file in one way or another. In another aspect, during isolation, the detection module 240 may analyze the behavior of the processes (threads) of the isolated file. In response to detecting no vulnerabilities (decision block 314, “NO” branch), at step 316, the system may return back to step 312, as shown in FIG. 3.

FIG. 4 shows an example of a computer system on which variant aspects of systems and methods disclosed herein may be implemented. The computer system 20 may represent the system configured to implement a method for detecting vulnerabilities in an operating system based on process and thread data of FIG. 2 and can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for detecting a vulnerability in an operating system based on process and thread data, comprising:
detecting one or more launches of one or more threads associated with one or more processes in an operating system (OS);
generating a set of privileges based on the detected one or more launches;
analyzing the generated set of privileges to identify illegitimate changes in privileges;
detecting a vulnerability in the OS using one or more rules for detecting a vulnerability based on the analyzed set of privileges; and
isolating a file that exploited the detected vulnerability, in response to detecting the vulnerability.

2. The method of claim 1, wherein the set of privileges comprises a data set containing data about the one or more threads, one or more processes, and security context, wherein the security context includes access token information and a list of privileges.

3. The method of claim 1, wherein the generated set of privileges is analyzed by identifying at least one privilege usage event in the OS.

4. The method of claim 3, wherein the at least one privilege usage event in the OS is detected by intercepting an OS event containing updated privilege indicative of an activity of one or more malicious applications.

5. The method of claim 1, wherein the one or more launches are detected by intercepting an OS event that indicates a launch of a new thread or a launch of a new process.

6. The method of claim 2, wherein the generated set of privileges is analyzed by identifying one or more access tokens that have been changed.

7. The method of claim 1, wherein each of the one or more rules for detecting a vulnerability comprises a set of conditions which indicate presence of a vulnerability in the OS if the conditions are met.

8. A system for detecting a vulnerability in an operating system based on process and thread data comprising:
a memory and a hardware processor configured to:
detect one or more launches of one or more threads associated with one or more processes in an operating system (OS);
generate a set of privileges based on the detected one or more launches;
analyze the generated set of privileges to identify illegitimate changes in privileges;
detect a vulnerability in the OS using one or more rules for detecting a vulnerability based on the analyzed set of privileges; and
isolate a file that exploited the detected vulnerability, in response to detecting the vulnerability.

9. The system of claim 8, wherein the set of privileges comprises a data set containing data about the one or more threads, one or more processes, and security context, wherein the security context includes access token information and a list of privileges.

10. The system of claim 8, wherein the hardware processor configured to analyze the generated set of privileges is further configured to identify at least one privilege usage event in the OS.

11. The system of claim 10, wherein the hardware processor configured to detect the at least one privilege usage event in the OS is further configured to intercept an OS event containing updated privilege indicative of an activity of one or more malicious applications.

12. The system of claim 8, wherein the hardware processor configured to detect the one or more launches is further configured to intercept an OS event that indicates a launch of a new thread or a launch of a new process.

13. The system of claim 9, wherein the hardware processor configured to analyze the generated set of privileges is further configured to identify one or more access tokens that have been changed.

14. The system of claim 8, wherein each of the one or more rules for detecting a vulnerability comprises a set of conditions which indicate presence of a vulnerability in the OS if the conditions are met.

15. A non-transitory computer readable medium storing thereon computer executable instructions for detecting a vulnerability in an operating system based on process and thread data, including instructions for:
detecting one or more launches of one or more threads associated with one or more processes in an operating system (OS);
generating a set of privileges based on the detected one or more launches;
analyzing the generated set of privileges to identify illegitimate changes in privileges;
detecting a vulnerability in the OS using one or more rules for detecting a vulnerability based on the analyzed set of privileges; and
isolating a file that exploited the detected vulnerability, in response to detecting the vulnerability.

16. The medium of claim 15, wherein the set of privileges comprises a data set containing data about the one or more threads, one or more processes, and security context, wherein the security context includes access token information and a list of privileges.

17. The medium of claim 15, wherein the generated set of privileges is analyzed by identifying at least one privilege usage event in the OS.

18. The medium of claim 17, wherein the at least one privilege usage event in the OS is detected by intercepting an OS event containing updated privilege indicative of an activity of one or more malicious applications.

19. The medium of claim 15, wherein the one or more launches are detected by intercepting an OS event that indicates a launch of a new thread or a launch of a new process.

20. The medium of claim 16, wherein the generated set of privileges is analyzed by identifying one or more access tokens that have been changed.
